(19) United States
(12) Patent Application Publication
(10) Pub. No.: US 2006/0153983 A1
(43) Pub. Date: Jul. 13, 2006

(54) Hydrothermal deposition of thin and adherent metal oxide coatings for high temperature corrosion protection

(76) Inventors: Xiangyang Zhou, Miami, FL (US); Zhuang Fei Zhou, State College, PA (US); Serguei N. Lvov, Bellefonte, PA (US); Digby D. Macdonald, State College, PA (US)

Correspondence Address: DERGOSITS & NOAH LLP, FOUR EMBARCADERO CENTER, SUITE 1450, SAN FRANCISCO, CA, 94111, US

(21) Appl. No.: 11/347,396

(22) Filed: Feb. 2, 2006

Related U.S. Application Data
(63) Continuation-in-part of application No. 10/460,609, filed on Jun. 11, 2003, now abandoned.
(60) Provisional application No. 60/422,745, filed on Oct. 30, 2002.

(51) Int. Cl. B05D 3/02

(52) U.S. Cl. 427/226

(57) ABSTRACT

A metal oxide layer can be deposited onto surface of a structure in-situ, by exposing the surface to a precursor solution at an elevated temperature. The precursor solution contains: an organometallic, an oxidant, a surfactant, a chelating agent and water. The precursor solution is injected into the structure and maintained at a specific temperature, pH level, and pressure for a predetermined period of time. The resulting metal oxide layer is permanently attached to the structure's surface with a molecular interface bond and does not require post deposition heat treatment or additional injections of materials. As a result, the electrochemical corrosion potential of the metal surface decreases to less than −230 mV_{SHE} and corrosion in the BWR is mitigated.

### CROSS REFERENCE TO RELATED APPLICATIONS

The present application is a continuation-in-part of U.S. patent application Ser. No. 10/460,609 filed Jun. 11, 2003, entitled “Hydrothermal Deposition of Thin and Adherent Metal Oxide Coatings for High Temperature Corrosion Protection.” The present application also claims priority to abandoned U.S. Patent Application No. 60/422,745 filed Oct. 30, 2002 and also entitled “Hydrothermal Deposition of Thin and Adherent Metal Oxide Coatings for High Temperature Corrosion Protection.” U.S. patent application Ser. No. 10/460,609 and 60/422,745 are both hereby incorporated by reference.

### BACKGROUND

A boiling water reactor (BWR) is a steam generating system consisting of a nuclear core, an internal structure contained within a pressure vessel, and associated systems. Heat produced in the reactor core boils water, producing steam that is used to drive turbine generators, which produce electrical energy.

A problem associated with BWR systems is that many of the metal components are exposed to high temperature and high pressure fluids that can cause electrochemical corrosion and intergranular stress corrosion cracking (IGSCC). IGSCC can result in failure of key metal components, so the development of countermeasures to mitigate IGSCC are desirable. Electrochemical corrosion is caused by electrons flowing from anode areas to cathode areas of the same surface of a BWR. IGSCC of the metal components is due to exposure to oxidizing molecules in the fluid flowing through the BWR system. In particular, water used to cool a reactor core suffers radiolysis, leading to decomposition of some of the water molecules into oxidizing radicals.

The electrochemical corrosion potential (ECP) is a measure of a corrosion process and involve a number of oxidation/reduction (REDOX) reactions that occur on the exposed metal surfaces of the BWR. The REDOX reactions are dependent upon the concentrations of dissolved O₂, H₂ and H₂O₂ in the water. The ECP is reduced by lowering the exchange current densities for the reduction of oxygen and hydrogen peroxide. The ECP is also reduced by increasing the exchange current density for the oxidation of hydrogen. ECP probes are available to monitor the ECP levels in a BWR system. The ECP level is related to the IGSCC of the metal components. Specifically, IGSCC is accelerated when the ECP is above the “critical value” of −230 mV_{SHE} (measured on the standard hydrogen electrode scale). In contrast, when the ECP is below this critical value, the IGSCC of the metal components is negligible.1

One example of a large structure that is subject to corrosion degradation and IGSCC is the core internals of a BWR in a commercial nuclear power plant. In boiling water reactors, radiolysis generates a large amount of oxidants, mainly O₂ and H₂O₂. These oxidants are dissolved in the cooling water and cause the electrochemical potential (ECP) of stainless steel and Ni-based alloy tubes, pipes, and vessels to rise to a level at which IGSCC can occur.

Also, neutron activation in the reactor core generates radioactive species, such as Co-60 and N-16. The radioactive Co-60 species can be absorbed into the surface of the oxide films, such as spinel oxides, that form on stainless steel and Ni-based alloys (e.g. Alloy 600), thereby increasing the radioactivity of these components. The increased radioactivity of the components may result in an undesirable increase in radiation exposure of reactor personnel.

It is desirable to minimize corrosion and IGSCC by keeping the ECP below the critical value in BWR systems. There are several known methods for reducing the ECP. The ECP can be reduced by adding high levels of hydrogen to the feed water flowing through the BWR system. The hydrogen combines with the oxidants in the water and thereby prevents the oxidants from reacting with exposed metal components and raising the ECP. Two problems with hydrogen injection systems are that they are expensive to install and that they increase the radiation build-up on ex-core _{[PC1]}reactor components. Another problem with hydrogen injection systems is that not all BWR system components are protected from IGSCC using this approach.

A method for improving the effectiveness of hydrogen injection is to deposit a discontinuous layer (e.g. discrete nanometer-sized particles) of a noble metal such as Pt and Pd onto the exposed surfaces. An alternative implementation is to dissolve, in solid solution, a very small amount of noble metals into the structural metals (i.e. dope the structural metals) during the latter's fabrication and processing. The noble metals act as a catalytic material that increases the reactions between oxidants and the injected hydrogen. The noble metal improves the efficiency, so that the amount of hydrogen needed to lower the ECP below the critical potential is reduced. However, hydrogen injection is still required for both the noble metal coating (NMC) and the related doping technologies.

Another means for reducing the ECP is to continuously inject a metal hydride into the high temperature water. Although the ECP is lowered when the metal hydride are injected, the ECP rises above the critical potential level after a short period of time after the injections are stopped. Thus, in order to maintain the reduced ECP, the metal hydrides must be continuously injected.

One of the methods for permanently reducing the ECP is to deposit a dielectric coating, such as ZrO₂, on the metallic components in BWR systems. An electrically insulative coating lowers the ECP and inhibits IGSCC in high temperature BWR applications without the need for injecting hydrogen into the feed water. The dielectric layer inhibits charge transfer and decreases the exchange current densities of all REDOX reactions that occur on the surface, thereby decreasing the corrosion current density of the metal. When the exchange current densities of the reduction reactions decrease significantly more than the exchange current density of the dominant oxidation reaction (that of the metal), the value of the ECP also decreases. Again, if the ECP is maintained below the critical level, IGSCC is minimized.

There are many known methods for forming dielectric metal oxide coatings including: chemical vapor deposition (CVD), physical vapor deposition (PVD), thermal spray, ion sputtering, sol-gel, electrophoretic deposition, electrochemical deposition, etc. These methods have the benefit of forming a permanent electrically insulative layer on the stainless steel structure and, therefore, there is no need for injections of any additional materials to keep the ECP levels low. However, many of these metal oxide deposition methods require complex machinery that is not easily adaptable for depositing coatings on complex and intricately shaped BWR components. For example, it may be prohibitively difficult to use these systems to apply an electrically insulative layer on the internal surfaces of BWR tubes and pipes. The piping systems must typically be disassembled before the electrically insulative layer is deposited.

What is needed is a system that allows an electrically insulative layer to be deposited onto stainless steel or, more generally, onto the surfaces of the structural alloys of the BWR system to keep the ECP levels low, without injections of additional materials.

### SUMMARY OF THE INVENTION

The present invention is an in-situ method for forming a thin, dense, adherent metal-oxide coating on metallic surfaces that can lower the ECP to values below which IGSCC is mitigated in BWR systems. The metal-oxide layer is deposited by injecting a liquid precursor into a structure and heating the precursor. The metal oxide is deposited onto areas of the structure that are in contact with the precursor and are heated to a temperature between approximately 170 C and 220 C. The inventive metal oxide coating method is particularly useful in depositing metal oxides on the internal surfaces of tubes, pipes, and vessels that have been assembled into a complex structure such as a BWR system.

In an embodiment, a layer of zirconium oxide is deposited onto the interior stainless steel surfaces of a BWR system. The liquid precursors are stored and injected into the structure from two pressure vessels. A first pressure vessel containing an organometallic compound and a second pressure vessel containing a mixed solution are connected to the BWR system with appropriate valves, piping, and instrumentation. The organometallic compound may include Zr-n-propoxide and 1-propanol. The mixed solution may include: an oxidant, a surfactant, a chelating agent, and water. The organometallic and mixed solutions are injected into the structure to be protected against IGSCC from the two pressure vessels by opening valves so the fluids flow into the structure. By filling the structure, the liquid precursor comes into contact with all exposed interior surfaces and deposits a layer of ZrO₂. The temperature of the structure and fluids are maintained at an elevated temperature by heaters. The injected liquid precursor flows through the structure and out through a pressure relief valve that controls the internal pressure of the structure.

The bonding of the ZrO₂ is achieved through chemical reaction with the structural alloy. The oxidant in the precursor solution oxidizes the surfaces of the structure. In a stainless steel structure the oxidant causes an iron-oxide film to form on the exposed surfaces. In the context of this document, this iron oxide will be called a “native oxide” because it is formed from constituent metallic elements present in or native to the stainless steel itself. As part of this process, Fe²⁺ and Fe³⁺ cations are produced. These cations combine with hydroxyl ions in the precursor solution flowing through the structure to form Fe(OH)₂ and Fe(OH)₃. An interface bond is formed between the ZrO₂ and the native iron-oxide film on the exposed surfaces of stainless steel or, more generally, between the ZrO₂ and the exposed surfaces of the structural alloys of the BWR system.

Various deposition processing conditions are maintained by a control system so that the deposited ZrO₂ layer is non-porous, dense, of acceptably uniform thickness, and is securely bonded to the exposed surfaces. The deposition conditions are monitored by pressure transducers, thermocouples, oxygen probes, reference electrodes, and pH probes. Based upon the feedback from the sensors, a control system can make various adjustments to the system components. For example, during a deposition process, the pressure and flow rate can be controlled by adjusting the relief valve, the flow valves, and possibly the pump output pressure. The precursor temperature can be controlled by adjusting the electrical power to the heaters. The precursor chemical mixture can be adjusted by controlling the injection flow of the precursor components. The pH level can be controlled by titration of the precursor by the control system.

In particular, the deposition of the metal-oxide layer onto a stainless steel surface is affected by the pH level of the precursor solution and the surface charge density of the structure. For a strong interface bond, the target surface and the zirconia particles need to have opposite charges. The surface charge density is influenced by the pH of the precursor fluid. At low pH the zirconia particles may be more positively charged and at a higher pH they are more negatively charged. In the preferred embodiment, the pH level is in a relatively narrow range of about 5.5 to 7.0. When the pH is within this range, the structure's surface and the particles are oppositely charged, metal-oxide deposition occurs, and, during the metal-oxide deposition, an interface bond forms. If the pH level is outside of this range, the surface and particles have the same charge, and metal-oxide deposition does not occur.

The inventive process has identified the critical factors that must be controlled (i.e., the precursor solution chemistry and deposition parameters such as temperature, solution composition and pH, and flow rates) to be able to deposit zirconium oxide films with the desired attributes. It is an improvement over prior-art methods of depositing metal oxides, because the deposition can be performed in-situ and without the need for continuous injections of materials.

Many metal-oxide deposition systems require special equipment and cannot deposit acceptably uniform metal oxide on large or complex-shaped surfaces. The inventive system does not require extremely complex equipment to deposit the electrically insulative layer. Some known metal-oxide deposition processes such as sol-gel, electrophoretic, and electroless plating technologies require post-deposition heat treatment such as drying and calcination. These post-deposition heat-treatment procedures are impractical when applied to the large and complex structures found in a BWR. The inventive metal-oxide deposition process is an improvement over these deposition methods because it does not require post-deposition heat treatment, simplifying the deposition process.

The present invention is also an improvement over systems that require continuous injections of metal hydrides. The inventive system deposits a permanent layer of metal oxide onto the interior stainless steel surfaces of a BWR system, with an interface bond between the stainless steel and metal-oxide layer. Additional injections of materials are not required to maintain the ECP levels below the “critical value” of −230 mV_{SHE}.

### BRIEF DESCRIPTION OF THE DRAWINGS

The invention is herein described, by way of example only, with reference to embodiments of the present invention illustrated in the accompanying drawings, wherein:

FIG. 1 is a drawing of an embodiment of one metal-oxide deposition system;

FIG. 2 is a drawing of an embodiment of a second metal-oxide deposition system;

FIG. 3 is a graph illustrating the relationship between the surface charge density and the pH level of the precursor solution for depositing the metal oxide;

FIG. 4 is a drawing of the chemical reaction that bonds the metal oxide to an exposed stainless steel surface;

FIG. 5 is a drawing of the molecular bond of the metal oxide to an exposed stainless steel surface; and

FIG. 6 is a graph illustrating the change in ECP during the metal oxide deposition process.

### DETAILED DESCRIPTION

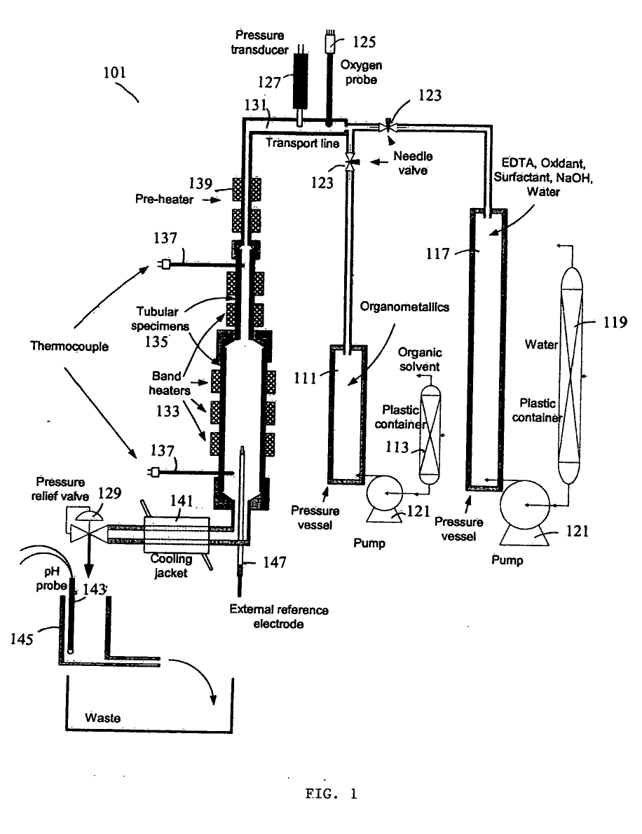

An embodiment of the inventive system will be described with reference to FIG. 1. The exemplary structure is a water loop 101 which may be an industrial component that is subject to a large temperature gradient across the wall thickness. This type of structure includes the fuel rod cladding in nuclear power plants and pipes in the heating furnaces of refineries.

An organometallic compound is contained in a first pressure vessel 111 and an organic solvent is stored in a first container 113. A pump 121 pumps the organic solvent into the first pressure vessel 111 and pressurizes the first pressure vessel 111. A second pressure vessel 117 stores a mixed solution that includes a chelating agent, an oxidant, a surfactant, and water. Pure water contained in a second container 119 is pumped through pump 121 to the second pressure vessel 117 pressurizing the second pressure vessel 117. Valves 123 are used to control the flow of fluids from the first pressure vessel 111 and the second pressure vessel 117 into the structure 135 upon which a metal oxide layer is to be deposited. The vales 123 may also be used to stop the flow of from the first pressure vessel 111 and the second pressure vessel 117 in case of an emergency.

The inventive system is described as having a first pressure vessel 111 containing an organometallic compound and a first container 113 containing an organic solvent. In an alternative embodiment, a single pressure vessel can contain both the organometallic and the solvent. The inventive system is described as having a second pressure vessel 117 containing chelating agent, oxidant, surfactant, and water; and a second container 119 containing pure water. In an alternative embodiment, the second container is not necessary.

The structure 135 is comprised of two tubular specimens of different diameters mounted in series. In the particular configuration of FIG. 1, they form the walls of a “deposition reactor,” but are also, at the same time, the specimens upon which a metal oxide is to be deposited. In addition, an object, for example a rectangular specimen (not shown in FIG. 1), can be placed within the structure 135 to test a different geometry to be exposed to the heated precursor.

The organometallic compound and mixed solution are pumped into the transport line 131 where they are mixed to form the precursor solution. The pumps 121, relief valves 129 and valves 123 control the pressure within the first pressure vessel 111 and the second pressure vessel 117.

The precursor may be heated with pre-heaters 139 before flowing into the structure 135. The precursor then flows into the structure 135 to deposit the metal oxide layer via a series of physical and chemical processes. While in the main structure 135, the precursor is heated by band heaters 133 mounted around the structure 135. The metal oxide layer is deposited on surfaces of the structure 135 which contact the precursor fluid and where the proper deposition temperature can be maintained. The metal oxide is deposited on the interior surfaces of the structure 135 as well as upon any objects within the structure 135 that are exposed to the heated precursor.

During the metal oxide deposition process, parameters including temperature, pressure, and pH level are monitored by proper probes and controllers (not shown). The controllers maintain the optimum metal oxide deposition conditions. The temperature of the precursor is monitored with thermocouples 137. If the monitored temperature falls outside the optimum range, the temperature controller adjusts power to the band heaters 133 to correct the temperature of the structure 135 and the precursor. Specifically, power to the band heaters 133 is increased if the monitored temperature is too low and power is decreased if the monitored temperature is too high.

A pressure transducer 127 monitors the internal pressure of the structure 135. The pressure relief valve 129 is set to prevent the internal pressure from exceeding a predetermined set pressure. If the internal pressure exceeds the set pressure, the relief valve 129 increases the precursor flow rate out of the structure 135. The controller may also reduce the flow of the precursor components into the structure 135. If the internal pressure drops below the desired level, the relief valve 129 reduces the precursor flow rate out of the structure. The controller may also increase the flow of precursor into the structure 135 by opening the valves 123 or by increasing the output of the pumps 121.

The dissolved oxygen level in the transport line is monitored with an oxygen probe 125. In a BWR system that does not have an electrically insulative layer, the ECP of the structure increases with the oxygen level. The ECP is monitored using the external reference electrode 147. The ECP level is indicative of the corrosion potential and the susceptibility to IGSCC. As discussed, when the ECP is below about −230 mV_{SHE}, the IGSCC is considered mitigated. By monitoring the ECP level, the effectiveness of the metal oxide layer can be determined. Before the metal oxide deposition process, the ECP level may be well above −230 mV_{SHE}. As the metal oxide is deposited, the ECP level drops below −400 mV_{SHE}, effectively mitigating IGSCC, regardless of the oxygen level.

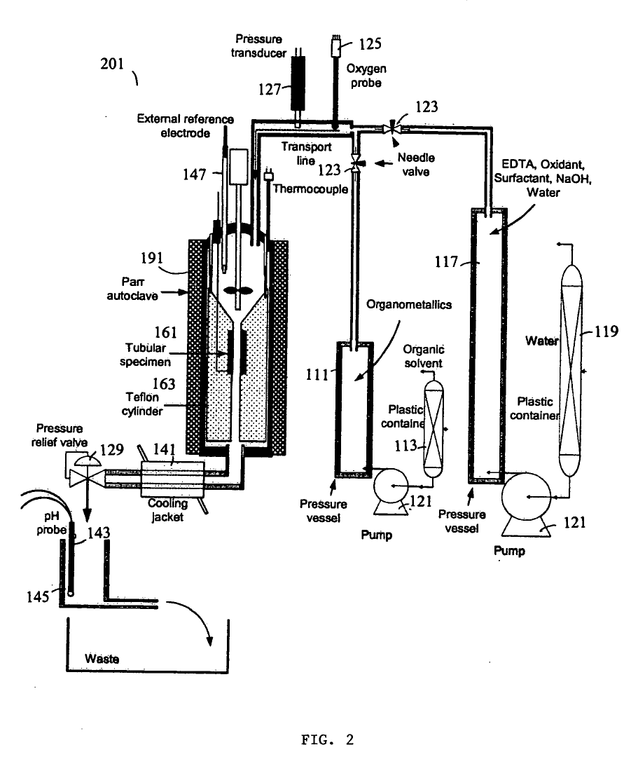

The used precursor solution passes through a cooling jacket 141 to reduce the temperature of the fluid and exits the structure 135 through a pressure relief valve 129. The used precursor solution flows into a temporary holding tank 145 where the pH value is measured with a pH probe 143. The controller detects the pH level and may adjust by titration the mixture of the precursor components to correct the pH error. The controller may titrate the precursor by controlling the flow of precursor components into the structure 135 through adjustment of the valves 123. FIG. 2 illustrates a structure that is subject to a small temperature gradient across the wall thickness, illustrative of applications such as thermally insulated pipes and tubes in the cooling circuits of nuclear power plants. The structure is similar to the water loop illustrated in FIG. 1, but utilizes an autoclave 191 to heat the fluid rather than pre-heaters and band heaters. The components having like reference numbers function in the same manner described with reference to FIG. 1. In FIG. 2, a tubular specimen 161 and a Teflon cylinder 163 are placed within the autoclave 191. The Teflon cylinder 163 covers the outer surfaces of the specimen 161. Only the interior surfaces of the specimen 161 are exposed to the heated precursor solution and coated with a metal-oxide layer. The metal oxide will not adhere to the Teflon cylinder 163. Various other system configurations that allow the precursor solution mixture, the internal temperature and pressure, and pH to be controlled are within the scope of this patent.

The metal oxide layer is deposited onto metal surfaces through a series of chemical reactions between the target structure and the precursor solution. While the intended application is for deposition onto metals, the process should also be effective for deposition onto ceramics. The following disclosure is directed to the chemical reactions an embodiment of the inventive process used to deposit a zirconium-oxide layer on a stainless steel surface. The composition of the precursor comprises: zirconium isopropoxide—organometallic, 1-propanol—organic solvent, ZrO(ClO₄)₂—oxidant, C₁₂H₂₅O₄SNa (SDS)—surfactant, ethylenediaminetetraacetic acid (EDTA)—chelating agent, NaOH and water. The zirconium-oxide deposition reactions include: hydrolysis of the organometallic, formation of suspended particles of appropriate size, adsorption of suspended particles onto the surface, and interface bond formation.

The hydrolysis of zirconium isopropoxide is represented by the equation
nZr(OR)₄+4nH₂O=nZr(OH)₄+4nROH
where the term “R” refers to an organic chain. Hydrolysis of the zirconium isopropoxide yields the suspended zirconia particles. If the hydrolysis rate is too fast and a large amount of organometallic is hydrolyzed in a short period of time, the zirconia particles can grow into undesired, large aggregates. The amount of organometallic available for hydrolysis is regulated by controlling the relative injection rates of the organometallic compound and the mixed solution.

The size of the suspended zirconia particles in the precursor is another factor that affects the zirconium-oxide layer deposition. Minimizing the particle size enhances the stability of the suspension and allows the suspended particles to flow with the precursor to the desired deposition locations. Small particles are also more chemically active and, therefore, produce denser zirconium oxide layers that are securely bonded to the target structure. Large particles can produce loose coatings that are poorly chemically bonded.

The size of the suspended zirconia particles is affected by the EDTA chelating agent. At elevated temperatures (>100° C.), EDTA will complex with the suspended particle. Complexing with the EDTA results in smaller particles by partly dissolving the larger particles. For optimum zirconium-oxide deposition, it is desirable to produce particles as small as possible, or preferentially below 200 nm, while avoiding complete dissolution of these particles since particles are necessary for depositing a metal-oxide coating. The process of particle dissolution can be adjusted by changing the pH, flow rate, or residence time. The complexation reaction between EDTA and the zirconia particles is
Zr(OH)₄+H₄EDTA=Zr—H₂EDTA²⁺+2OH⁻+2H₂O.

The adsorption of the suspended particles on a metal surface is caused by variations in the surface charges of the structure. The surface charges are affected by protonation and ionization of the surface hydroxide groups. In these processes, —OH₂⁺ or —O⁻ entities can be formed on the exposed metal surfaces depending on the pH of the precursor.

At a low pH level, more H⁺ ions exist in the precursor, and the following reaction occurs
(M−OH)_{surface}⁰+Hₛₒₗᵤₜᵢₒₙ⁺=(M−OH₂)_{surface}⁺.

At a higher pH level, more OH⁻ ions exist and the following reaction occurs
(M−OH)_{surface}⁰+OHₛₒₗᵤₜᵢₒₙ⁻=(M−O)_{surface}⁻+H₂O .

In the chemical equations, (M−OH)_{surface}⁰, (M−OH₂)_{surface}⁺ and (M−O)_{surface}⁻ are the surface groups of the native oxide or of suspended oxide particles. The surface groups are part of an acid and base equilibria. Because each reaction site occupies a specific area, there are a fixed number of reaction sites per unit area of the exposed surface.

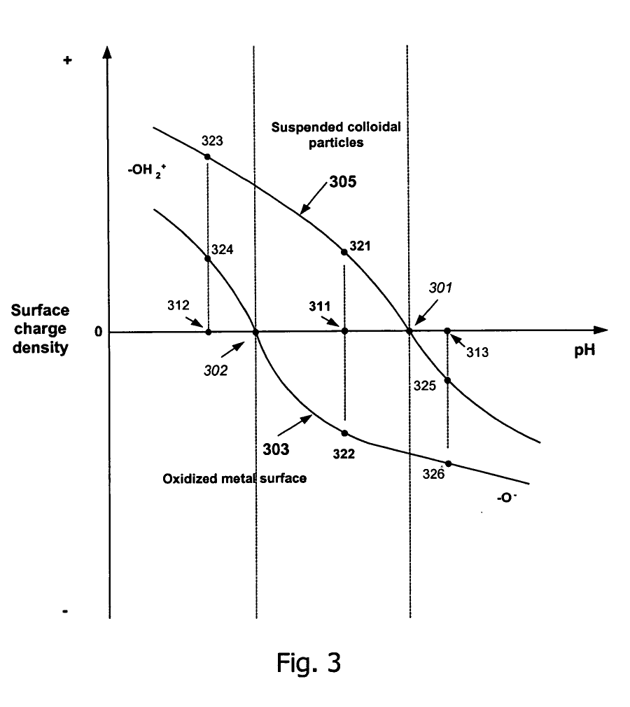

FIG. 3 graphically illustrates the relationship between surface charge density and pH level. The horizontal axis corresponds to a surface charge equal to zero. The region above the horizontal axis is representative of the condition where there are more of (M−OH₂)_{surface}⁺, and the region below the axis is representative of the condition where there are more of (M−O)_{surface}⁻. When the surface charge (zeta potential) is zero, there is an equal population of (M−OH₂)_{surface} ⁺ and (M−O)_{surface}⁻ groups. When the surface charge is zero, the condition is known as isoelectric point (IEP) or “pH of zero charge” (PZC).

The film deposition system consists of a stainless steel surface (or more generally, of surfaces of structural alloys) that is covered by a pre-existing native oxide comprising metal oxides such as Fe₂O₃, Cr₂O₃, and NiO; along with suspended ZrO₂ particles and the solution. Thus, according to the above analysis, the surface charge (and zeta potential) of both the oxidized stainless steel surface and ZrO₂ particles are functions of pH of the solution. As an example with reference to FIG. 3, the curved lines 303 and 305 respectively represent the surface charge of the oxidized stainless surface and the surface charge of the suspended ZrO₂ particles, over a range of precursor solution pH values.

The horizontal axis represents the condition of surface charge density equals zero. For proper deposition, the surface charge (zeta potential) of the suspended ZrO₂ particles must be the opposite of the target oxidized stainless steel surface. For a range of pH values between PZC₁ (Point of Zero Charge) 301 and PZC₂ 3O₂, the surface charge of the suspended ZrO₂ particles are positive, and the surface charge of the target native-oxide-covered stainless steel surface is negative. For example, if the precursor solution is pH, 311, which is between PZC₁ 301 and PZC₂ 302, the surface charge of the suspended particles is positive, as indicated by point 321, and the surface charge of the native-oxide-covered stainless steel surface is negative, as indicated by point 322. At pH₁ 311, the suspended particles and the target stainless surface are oppositely charged and are attracted to each other, facilitating proper ZrO₂ deposition. During in-situ deposition, the precursor solution is titrated to obtain a precursor pH level between PZC₁ 301 and PZC₂ 302.

When the precursor solution pH is not between PZC₁ 301 and PZC₂ 302, ZrO₂ deposition does not occur because the ZrO₂ particles and the target surface have the same surface charge. For example, at pH₂ 312, which is lower than PZC₂ 302, the suspended metal-oxide particles are not deposited because the surface charge of the target surface 324 and the surface charge of the ZrO₂ particles 323 are both positively charged. Similarly, deposition does not occur at pH₃ 313, which is a higher pH than PZC₁ 301, because both the surface charge of the target surface 326 and the surface charge of the ZrO₂ particles 325 are negatively charged.

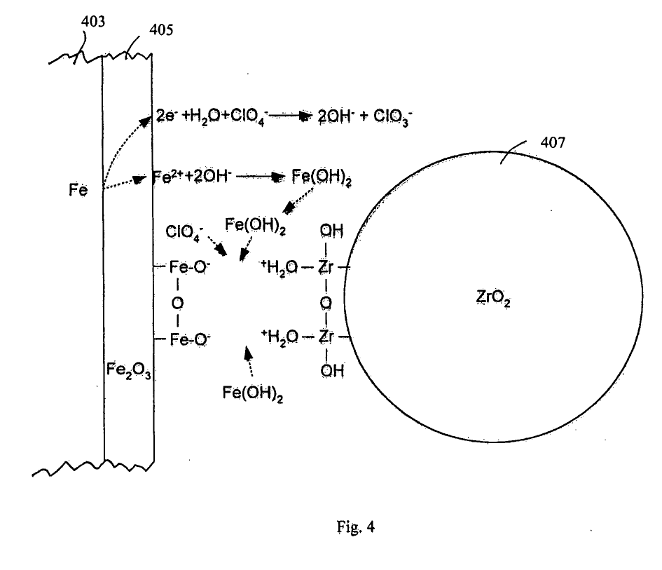

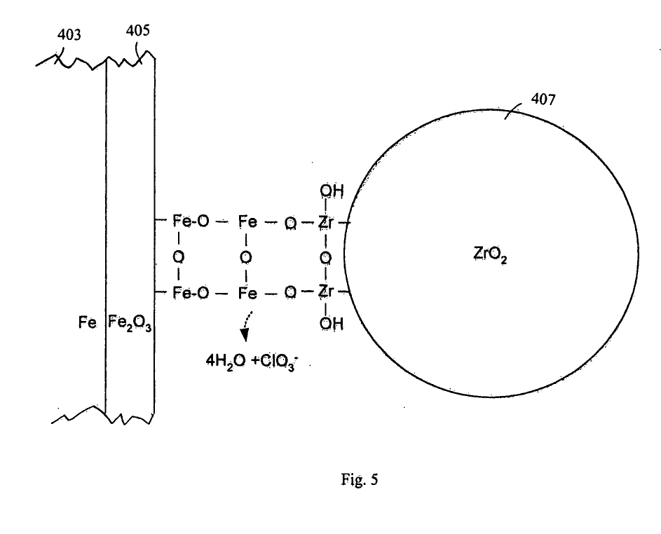

During metal-oxide deposition, an interface bond is formed between the deposited metal oxide and the exposed surface. The interface bond of the metal-oxide coatings is produced by chemical reactions of the precursor oxidant ZrO(ClO₄)₂. The oxidant oxidizes the target surface and forms covalent bonds at the interface of that surface and the zirconium oxide. FIGS. 4 and 5 illustrate the chemical reactions that occur for bonding of the metal oxide to the exposed metal. The target surface 403 represents a stainless steel surface having a native iron oxide layer 405.

With reference to FIG. 4, the oxidant ZrO(ClO₄)₂ promotes two chemical reactions to bond a layer of ZrO₂ to stainless steel. The first reaction is the dissolution of stainless steel 403, which produces Fe²⁺ or Fe³⁺ cations at the interface between the stainless steel 403 and the native iron oxide film 405. The cations diffuse into the water and combine with hydroxyl ions to form Fe(OH)₂ or Fe(OH)₃ via
Fe²⁺+2OH⁻═Fe(OH)₂ or Fe³⁺+3OH⁻═Fe(OH)₃.
[Only Fe(OH)₂ is illustrated in FIGS. 4 and 5.] The electrons that are released from the dissolution reaction are consumed by the coupled cathodic reaction
2e⁻+H₂O ═ClO₄⁻=2OH⁻+ClO₃⁻

As illustrated in FIG. 5, a second reaction involving the oxidant bonds the ZrO₂ molecules at the surface of the ZrO₂ particle 407 to the existing native iron-oxide film 405 on the target stainless steel surface 403, through a —O—Fe—O— linkage. The ClO₄⁻ and Fe(OH)₂ are consumed, while water and ClO₃⁻ are produced, in the formation of the interface bond. The interface bond is strong and is superior to a weak electrostatic attractive force and/or hydrogen bonds, which produces a loose and porous metal-oxide layer on the target surface. The reaction can occur at the interfaces between the target surface and the ZrO₂ particles that are attracted to and chemically adsorbed by the target surface, and at the interfaces between the ZrO₂ particles, if the particles are close (a few micrometers) to the target surface. In both situation Fe(OH)₂ can diffuse to the interfaces to form the interface bonds. If, however, the particles are too far from the target stainless steel surface, the bond reaction cannot occur due to lack of Fe(OH)₂. The bond reaction is accelerated at higher temperatures due to fast diffusion and fast reaction kinetics. However, a temperature higher than 220° C. results in other problems, such as severe corrosion and the decomposition of EDTA. The decomposition of EDTA dramatically changes the chemistry and pH of the solution, so that the condition for deposition will no longer exist.

The preferred chemical composition and processing conditions for the inventive hydrothermal method for depositing ZrO₂ on exposed surfaces of Type 304 stainless steel tubes were determined by experimentation. The experimental results are disclosed as follows. As discussed with reference to FIG. 1, the deposition system includes a first pressure vessel 111 which stores an organometallic compound, a first plastic container 113 which stores an organic solvent, a second pressure vessel 117 containing a mixed solution and a second container 119 containing water. In the experiment, the organometallic stored in the first pressure vessel 111 possessed a composition of relative proportions: Zr-n-propoxide (70%) 100 ml and 1-propanol 110 ml. The organic solvent stored in the container 113 was pure 1-propanol. The mixed solution in the second pressure vessel 117 possessed a composition of relative proportions: EDTA 70 g, ZrO(ClO₄)₂ 10 g, C₁₂H₂₅O₄SNa (SDS) 1.0 g, NaOH 24 g, and water 750 ml. The second container 119 stored pure water. The precursor components are injected into the transport line 131 where they mix and then flow through the interior of the stainless steel tubes 135. The pH level of the mixed solution in the second pressure vessel is around 5.6.

In this experiment, specific deposition conditions were maintained. The organic solvent, 1-propanol, was injected at a rate of 1.5 ml/min. The water injection rate from the second container into the second pressure vessel 117 was 15 ml/min. The temperature of the deposition solution was maintained between 170-220° C. The fluid pressure during the zirconium-oxide deposition was maintained between 500 psi to 1,500 psi. The oxygen concentration measured by the oxygen probe 125 was maintained between 3 to 10 ppm. The pH of the waste solution measured at the outlet by the pH probe 143 was between 5.5 to 7.0. The interior surfaces of the tubes were exposed to the heated precursor fluids for up to 40 hours.

At the end of the experimental deposition processes, acceptably uniform zirconium oxide coatings were produced on the exposed surfaces of the tubular specimens. The coatings were 1-4 μm thick, free of pores, and well bonded to the substrate metal. The test samples were examined with a scanning electron microscope, and an energy dispersive spectroscopy (EDS) analysis confirmed that the deposited film contained Zr. X-ray diffraction analysis of the test samples confirmed that the coating was monoclinic ZrO₂. AC impedance spectroscopic analysis indicates that the interface resistance of the zirconium oxide coating was about 10⁶ ohm cm². The zirconium-oxide coating resistance was substantially higher than the interface resistance of an uncoated stainless steel surface, which is typically about 300 ohm cm².

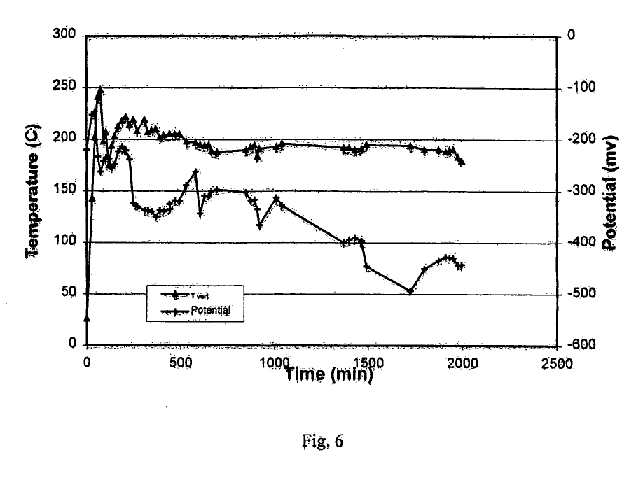

As discussed, the zirconium oxide layer protects the structure from IGSCC when the ECP of the structure is less than −230 mV_{SHE}. FIG. 6 shows the record of the process temperature and the ECP of the experimental tube samples during the deposition process. The ECP of the experimental samples with the zirconium oxide deposition decreased from −100 mV_{SHE} to below −400 mV_{SHE} within 35 hours of deposition processing. The reduction of the ECP below −230 mV_{SHE} mitigates the corrosion and IGSCC in Type 304 stainless steel in high temperature water that is common in BWR applications.

The inventive metal oxide deposition process provides a thin and adherent metal oxide coating that mitigates general corrosion, IGSCC, oxidation, and radiation buildup in hot and low temperature aggressive environments. The inventive process has several advantages over the prior art metal oxide deposition methods. The inventive process does not require complex industrial equipment. The inventive process is performed by pumping precursors into the structure. The precursors contact the interior surfaces of the structure. A required temperature and pressure are maintained in the structure to be coated. The application temperature of the inventive hydrothermal deposition process is lower than the application temperature of other coating technologies such as CVD, ion sputtering, cladding, and thermal spray. Temperatures in these processes can reach 500° C. and cause undesired structural transformations and thermal stresses in the substrate materials. The inventive process utilizes a one-step procedure that is an improvement over the prior art CVD, ion sputtering, cladding, and thermal spray methods because it does not require post-deposition heat treatment to achieve the desired results.

There are also numerous differences between the inventive system for depositing a metal oxide layer onto a stainless steel or ceramic surface and a system that requires the continuous injection of metal hydrides. The inventive system deposits a permanent layer of metal oxide onto a stainless steel surface in a single deposition step. The inventive system deposits a permanent electrically insulative layer that is attached to the interior surfaces with a strong molecular interface bond and that keeps the ECP below the critical value without any further processing steps after deposition. More specifically, after the electrically insulative layer is deposited, the system does not require the continuous injection of additional metal hydride materials to keep the ECP levels below the critical value.

In contrast to the inventive system, prior art system disclosed in U.S. Pat. No. 6,024,805, requires continuous injections of metal hydrides in order to maintain the ECP levels below the critical value. If the injections of metal hydride are stopped, the ECP levels rise above the critical value. The fact that the ECP levels rise after the injections are stopped suggests that any insulative layer that is deposited is not permanent and is not bonded to the interior surfaces of the stainless steel structure with a strong molecular interface bond.

In the foregoing, a system for depositing a metal-oxide layer on a structure has been described. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method for hydrothermally depositing a metal oxide layer, comprising the steps:
injecting a precursor solution comprising: an organometallic, an oxidant, a surfactant, a chelating agent and water into a structure;
heating the precursor solution to a temperature greater than 100° Centigrade;
exposing a portion of the structure to the heated precursor solution;
depositing the electrically insulative metal oxide layer onto a surface of the structure that is exposed to the precursor solution;
bonding the electrically insulative metal oxide layer to the surface of the structure with a molecular interface bond; and
maintaining an electrochemical corrosion potential of the structure below −230 mV_{SHE} without any additional injections of the precursor solution.

2. The method for depositing the metal oxide layer of claim 1 wherein the metal oxide is zirconium oxide, the organometallic is Zr-n-propoxide and the depositing step comprises bonding the zirconium oxide to the native iron-oxide layer on the surface of the structure.

3. The method for hydrothermally depositing the metal oxide layer of claim 1 further comprising the step:
pressurizing the structure to more than 300 psi during the deposition step.

4. The method for hydrothermally depositing the metal oxide layer of claim 1 wherein the pressurizing step comprises monitoring the internal pressure of the structure with a pressure transducer and decreasing the internal pressure with a pressure relief valve if the internal pressure exceeds 2,000 psi.

5. The method for hydrothermally depositing the metal oxide layer of claim 1 wherein the heating step comprises monitoring the temperature of the precursor solution with a thermocouple and increasing the power to an electrical heater in thermal communication with the precursor solution if the temperature of the precursor solution is less than 100° Centigrade.

6. The method for hydrothermally depositing the metal oxide layer of claim 5 wherein the heating step comprises monitoring the temperature of the precursor solution with a thermocouple and decreasing the power to the electrical heater if the temperature of the precursor solution is greater than 300° Centigrade.

7. The method for hydrothermally depositing the metal oxide layer of claim 1 wherein the metal oxide deposited is zirconium oxide, the organometallic is Zr-n-propoxide and the depositing step comprises bonding the zirconium oxide to the native iron-oxide layer on the surface of the structure.

8. The method for hydrothermally depositing the metal oxide layer of claim 7 wherein the oxidant is ZrO(ClO₄)₂ and the deposition step comprises a chemical reaction with the oxidant to bond the zirconium oxide to the iron oxide layer.

9. The method for hydrothermally depositing the metal oxide layer of claim 7 wherein the chelating agent is ethylenediaminetetraacetic acid and the injecting step comprises complexing suspended particles in the precursor solution with the chelating agent.

10. The method for hydrothermally depositing the metal oxide layer of claim 7 wherein the surface of the structure is the surface of stainless steel, and the depositing step comprises bonding the zirconium oxide to the native iron-oxide layer on the surface of the structure.

11. A method for hydrothermally depositing a zirconium oxide layer comprising the steps:
injecting a precursor solution comprising: an organometallic, an oxidant, a surfactant, a chelating agent and water into a structure;
heating the precursor solution to a temperature greater than 100° Centigrade;
exposing a portion of the structure to the heated precursor solution;
oxidizing a surface of the structure that is exposed to the precursor solution with the oxidant to facilitate subsequent bonding to the native-oxide layer of the solid electrically insulative layer of metal oxide; and
depositing the solid layer consisting of zirconium oxide onto the native-oxide layer;
forming a permanent molecular interface bond between the solid electrically insulative layer consisting of zirconium oxide and the native-oxide layer; and
reducing the electrochemical corrosion potential of the structure to less than −230 mV_{SHE} without any additional injections of the precursor solution into the structure.

12. The method for hydrothermally depositing the zirconium oxide layer of claim 11, further comprising the step:
removing the precursor solution from the structure.

13. The method for hydrothermally depositing the zirconium oxide layer claim 11, further comprising the step:
regulating the internal pressure of the structure with a pressure regulator.

14. The method for hydrothermally depositing the zirconium oxide layer of claim 11, further comprising the steps:
monitoring the temperature of the precursor within the structure with a thermocouple; and
regulating the temperature of the precursor within the structure by actuating a heating element.

15. The method for hydrothermally depositing the zirconium oxide layer of claim 11, further comprising the steps:
storing the organometallic in a first pressure vessel before the injecting step; and
storing the oxidant, the surfactant, the chelating agent and water in a second pressure vessel before the injecting step.

16. The method for hydrothermally depositing the zirconium oxide layer of claim 15 _{[PC2]}, further comprising the step:
titrating the organometallic in a first pressure vessel before the injecting step or titrating the oxidant, the surfactant, the chelating agent, and water mixture in a second pressure vessel prior to the injecting step.

17. The method for hydrothermally depositing the zirconium oxide layer of claim 11, further comprising the step:
detecting the pH level of the precursor solution.

18. A method for hydrothermally depositing a zirconium oxide layer onto a stainless steel surface of a structure in-situ, comprising the steps:
injecting a precursor solution comprising: an organometallic containing Zr-n-propoxide, an oxidant containing ZrO(ClO₄)₂ and water into the structure;
heating the precursor solution to a temperature between 170° and 220° Centigrade;
exposing a portion of the structure to the heated precursor solution;
oxidizing the stainless steel surface of the structure that is exposed to the precursor solution with the oxidant to facilitate subsequent bonding to the native iron-oxide layer of the solid electrically insulative layer of zirconium oxide;
depositing the zirconium oxide layer onto the stainless steel surface of the structure that is exposed to the precursor solution;
forming a permanent molecular interface bond between the layer of zirconium oxide and native iron-oxide layer; and
reducing the electrochemical corrosion potential of the structure to less than −230 mV_{SHE} without any additional injections of the precursor solution into the structure.

19. The method for hydrothermally depositing the zirconium oxide layer of claim 18, further comprising the step:
titrating at least some of the precursor solution components to a pH level between 5.5 and 7 before the injecting step.

20. The method for hydrothermally depositing the zirconium oxide layer consisting of claim 15, further comprising the step:
detecting the temperature of the precursor solution; and
controlling the temperature of the precursor solution during the heating step.
